(19) United States
(12) Patent Application Publication
(10) Pub. No.: US 2025/0252811 A1
(43) Pub. Date: Aug. 7, 2025

(54) SYSTEMS AND METHODS FOR GENERATING AN INTERACTIVE DISPLAY FOR PLAYER INDEXING

(71) Applicant: STATS LLC, Chicago, IL (US)

(72) Inventors: Christian MARKO, Graz (AT); Thomas BRUGGER, Graz (AT)

(73) Assignee: STATS LLC, Chicago, IL (US)

(21) Appl. No.: 19/040,976

(22) Filed: Jan. 30, 2025

Related U.S. Application Data
(60) Provisional application No. 63/549,767, filed on Feb. 5, 2024.

(51) Int. Cl. G07F 17/32; G06Q 50/34

(52) U.S. Cl. CPC G07F 17/323; G06Q 50/34; G07F 17/3288

(57) ABSTRACT

According to systems and techniques disclosed herein, a plurality of real-time event data including a plurality of real-time event actions of a player may be received. One or more event actions associated with a unique identifier may be updated with the plurality of real-time event actions. A unique index may be generated based on a plurality of weights applied to the one or more event actions associated with the unique identifier. The unique index may be generated in real-time as the plurality of real-time event data is received. An interactive display may be generated including at least a graphical representation of the one or more event actions associated with the unique identifier, a graphical representation of the plurality of weights applied to the one or more event actions, and the unique index. The interactive display may be generated in real-time as the plurality of real-time event data is received.

### CROSS-REFERENCE TO RELATED APPLICATIONS

This application claims the benefit of priority to U.S. Provisional Application No. 63/549,767, filed Feb. 5, 2024, which is incorporated by reference in its entirety.

### TECHNICAL FIELD

Various embodiments of this disclosure relate generally to computer-implemented techniques for generating an interactive display for player indexing, and, more particularly, to systems and methods for generating an interactive display for player indexing in real-time.

### INTRODUCTION

Assessing a player's performance (e.g., for that of a soccer player) generally includes analyzing the player's statistics from one or more games. However, if that analysis does not take place in real time, nor based on real-time, up-to-date events related to that player, the assessed performance may be out of date or incorrect. Further, for individuals who wish to predict a player's future performance (e.g., including determining odds based on the prediction), inaccessibility of real-time data or the factors that go into a prediction of performance, can lead to undesirable results.

Unless otherwise indicated herein, the materials described in this section are not prior art to the claims in this application and are not admitted to be prior art, or suggestions of the prior art, by inclusion in this section.

### SUMMARY OF THE INVENTION

In some aspects, the techniques described herein relate to a computer-implemented method for generating an interactive display, the method including: receiving, by a computing system, a plurality of real-time event data including a plurality of real-time event actions of a player; updating, by the computing system, one or more event actions associated with a unique identifier of the player with the plurality of real-time event actions; generating, by the computing system, a unique index based on a plurality of weights applied to the one or more event actions associated with the unique identifier, wherein the unique index is generated in real-time as the plurality of real-time event data is received; generating, by the computing system, an interactive display including at least a graphical representation of the one or more event actions associated with the unique identifier, a graphical representation of the plurality of weights applied to the one or more event actions, and the unique index, wherein the interactive display is generated in real-time as the plurality of real-time event data is received; and transmitting, to a user interface by the computing system, the interactive display.

In some aspects, the techniques described herein relate to a computer-implemented method, wherein the interactive display is formatted according to a set of ordering rules.

In some aspects, the techniques described herein relate to a computer-implemented method, wherein the ordering rules include a first ordering rule, the first ordering rule including displaying a first unique index relative to a second unique index in the interactive display based on the first unique index including a higher numerical value relative to the second unique index.

In some aspects, the techniques described herein relate to a computer-implemented method, wherein the plurality of real-time event actions of the player include at least one of a scored goal, a completed pass, an interception, a goal conceded, or no action.

In some aspects, the techniques described herein relate to a computer-implemented method, wherein the unique index is provided to an artificial intelligence predictive model as an input.

In some aspects, the techniques described herein relate to a computer-implemented method, wherein the plurality of weights are applied to the one or more event actions according to a set of rules.

In some aspects, the techniques described herein relate to a computer-implemented method, wherein the interactive display is configured to be filtered according to one or more of unique index or unique identifier.

In some aspects, the techniques described herein relate to a system for generating an interactive display, the system including: a memory storing instructions and a processor operatively connected to the memory and configured to execute the instructions to perform operations including: receiving, by a computing system, a plurality of real-time event data including a plurality of real-time event actions of a player; updating, by the computing system, one or more event actions associated with a unique identifier of the player with the plurality of real-time event actions; generating, by the computing system, a unique index based on a plurality of weights applied to the one or more event actions associated with the unique identifier, wherein the unique index is generated in real-time as the plurality of real-time event data is received; generating, by the computing system, an interactive display including at least a graphical representation of the one or more event actions associated with the unique identifier, a graphical representation of the plurality of weights applied to the one or more event actions, and the unique index, wherein the interactive display is generated in real-time as the plurality of real-time event data is received; and transmitting, to a user interface by the computing system, the interactive display.

In some aspects, the techniques described herein relate to a system, wherein the interactive display is formatted according to a set of ordering rules.

In some aspects, the techniques described herein relate to a system, wherein the ordering rules include a first ordering rule, the first ordering rule including displaying a first unique index relative to a second unique index in the interactive display based on the first unique index including a higher numerical value relative to the second unique index.

In some aspects, the techniques described herein relate to a system, wherein the plurality of real-time event actions of the player include at least one of a scored goal, a completed pass, an interception, a goal conceded, or no action.

In some aspects, the techniques described herein relate to a system, wherein the unique index is provided to an artificial intelligence predictive model as an input.

In some aspects, the techniques described herein relate to a system, wherein the plurality of weights are applied to the one or more event actions according to a set of rules.

In some aspects, the techniques described herein relate to a system, wherein the interactive display is configured to be filtered according to one or more of unique index or unique identifier.

In some aspects, the techniques described herein relate to a non-transitory computer-readable medium storing instructions that, when executed by one or more processors, perform operations including: receiving, by a computing system, a plurality of real-time event data including a plurality of real-time event actions of a player; updating, by the computing system, one or more event actions associated with a unique identifier of the player with the plurality of real-time event actions; generating, by the computing system, a unique index based on a plurality of weights applied to the one or more event actions associated with the unique identifier, wherein the unique index is generated in real-time as the plurality of real-time event data is received; generating, by the computing system, an interactive display including at least a graphical representation of the one or more event actions associated with the unique identifier, a graphical representation of the plurality of weights applied to the one or more event actions, and the unique index, wherein the interactive display is generated in real-time as the plurality of real-time event data is received; and transmitting, to a user interface by the computing system, the interactive display.

In some aspects, the techniques described herein relate to a non-transitory computer-readable medium, wherein the interactive display is formatted according to a set of ordering rules.

In some aspects, the techniques described herein relate to a non-transitory computer-readable medium, wherein the ordering rules include a first ordering rule, the first ordering rule including displaying a first unique index relative to a second unique index in the interactive display based on the first unique index including a higher numerical value relative to the second unique index.

In some aspects, the techniques described herein relate to a non-transitory computer-readable medium, wherein the plurality of real-time event actions of the player include at least one of a scored goal, a completed pass, an interception, a goal conceded, or no action.

In some aspects, the techniques described herein relate to a non-transitory computer-readable medium, wherein the plurality of weights are applied to the one or more event actions according to a set of rules.

In some aspects, the techniques described herein relate to a non-transitory computer-readable medium, wherein the interactive display is configured to be filtered according to one or more of unique index or unique identifier.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 depicts a block diagram illustrating a computing environment, according to example embodiments.

FIG. 2A depicts an exemplary graphical user interface incorporating the interactive display, according to one or more embodiments.

FIG. 2B depicts an exemplary table for player scoring, according to one or more embodiments.

FIG. 3 depicts an exemplary graphical user interface implemented using artificial intelligence, according to one or more embodiments.

FIG. 4A depicts a flowchart of an exemplary method for generating a user display, according to one or more embodiments.

FIG. 4B depicts an exemplary block diagram for generating a user display, according to one or more embodiments.

FIG. 5 depicts a flow diagram for training a machine-learning model, according to one or more embodiments.

FIG. 6A is a block diagram illustrating a computing device, according to example embodiments.

FIG. 6B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the present disclosure relate generally to computer-implemented techniques for generating an interactive display in real-time. The interactive display may provide a player index generated in accordance with the techniques disclosed herein. The index for each player may be generated and may be used to quantify the contribution (e.g., performance) of that player to a sporting event match. The index may be calculated using a number of statistics, for example, goals scored, opposing shots and/or attempted goals blocked, completed passes, interceptions, and the like. Weights that normalize these statistics across similar player roles/positions may be applied, with unique weights applied to respective player positions that may be unique (e.g., a goal keeper). These weights may allow for the assessment of a player's actual contribution to the match. Therefore, the index may be specific to the position of the player and may consider or weigh different statistics based on the position of the player.

The calculated index value may then be used to allow a ranking of all players, which may be filtered. The index value may therefore act as a single comparable performance metric to describe the performance of a player in real-time. The index value may be affected by numerous statistics which may change frequently throughout a game or match. In this way, the index may be generated in real-time to account for real-time data and events that describe player performance. The following therefore describes a system and methods that allow for a reliable and reproducible way to predict and/or analyze player performance in real time.

The use of real-time data and weights in generating the index and the interactive display may provide an improvement over scaled default ratings wherein a player begins at a default index value that increases or decreases based on performance. In the example of a player who is subbed in near the end of a game, their index may reflect that the player outperformed other players, when scaled default ratings are used. This may result in an inaccurate assessment of the player's performance. Techniques disclosed herein overcome such drawbacks by using a real time weighted index for each player. The interactive display may allow users to view, in real-time, the data and weights being applied to the data, to increase user trust in the output index value.

Accordingly techniques disclosed herein are, at least in part, directed to generating an interactive display that provides a reliable, transparent, and reproducible player index. Such an index may be generated based on transparent metrics which ensures predictability of index outcomes, based on player performance. A user may be able to rely on such an index to determine player performance across multiple sporting events, multiple players, and/or across multiple seasons of a given sport. Accordingly, the index described herein is objective, understandable, and reproducible such that a user may be willing to rely on the index (e.g., and associated odds) as they understand how and/or when an odd based prediction is applicable, such that a bookmaker is confident enough to offer the corresponding market, or a market prediction submitter is confident enough to place a prediction, based on the index.

The index provided herein may allow rating and/or ranking of players that can be updated in real time and/or offered at the conclusion of a sporting event. For example, a market based on a player on a match day in a given league may allow odds based activity associated with a player that played in a Saturday noon fixture until the match day closes with a Monday night sporting event as the player delivered a good performance on Saturday. Based on the unified index disclosed herein, predictions may be made to set the probability of the player being one or more of the player of the match day, being in the top 11 set of players for the match day, being the best in a given position, etc.

Techniques disclosed herein offer advantages, in addition to those disclosed above. Techniques disclosed herein improve existing technology by, for example, transforming real time sports data captured using technical components into a practical application for evaluating players based on such real time sports data and further by formatting the evaluation (e.g., via generated index scores) for output to users in a comparable format. The techniques include providing an open ended index (e.g., score) which allows a larger variety compared to a compressed output (e.g., between 0-10) which may result in multiple overlapping indexes. The techniques disclosed herein provide an explainable index calculation providing transparency and trust. Such an expandable index calculation may also all the offering of odds based activity that may be implemented with a threshold level of confidence. The techniques disclosed provide an index based on actual player contribution such that it is unlikely that a player who is substituted into a game (e.g., with limited time remaining) will not have an index corresponding to a top performer based on a team wide index.

Further, the generated data, such as the index, may be used as input into a machine-learning or artificial intelligence model. In examples, a user may be able to interact with a language learning model (LLM) that is trained to output responses to user questions, using the generated data. In this way, a user may interact with live event data and live output (e.g., the index).

Therefore, the present disclosure also provides machine-learning based techniques for performance prediction. Additionally, using artificial-intelligence based techniques for natural language processing may allow for user interaction with the data. The logistical and financial challenges and/or undesired results associated with determining odds for anticipated player performance may be also be reduced. More specifically, techniques disclosed herein to generate an index for each player may provide for faster, real-time, more accurate, more efficient, and tailored processing of game event data in comparison to conventional techniques. Techniques disclosed herein further reduce the computational resources required for such processing by, for example, leveraging machine learning training to reduce just-in-time processing loads. Real-time may include information that may be made available at the time of or substantially at the time of the occurrence of an event (e.g., within milliseconds). Just-in-time may include information that may be made available within a certain time period (e.g., in under approximately 10 minutes, approximately 1 minute, approximately 30 seconds, etc.).

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

Other embodiments of the disclosure will be apparent to those skilled in the art from consideration of the specification and practice of the invention disclosed herein. It is intended that the specification and examples be considered as exemplary only.

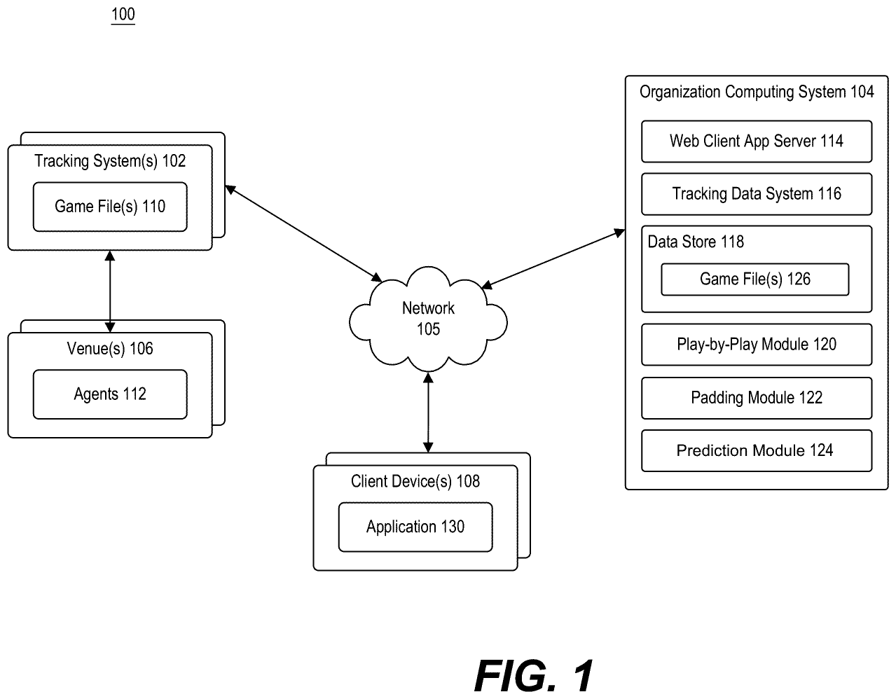

FIG. 1 is a block diagram illustrating a computing environment 100, according to example embodiments. Computing environment 100 may include tracking system 102 (e.g., positioned at or in communication with one or more components positioned at venue 106), organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106 and/or may be in communication (e.g., electronic communication, wireless communication, wired communication, etc.) with components located at venue 106. For example, venue 106 may be configured to host a sporting event that includes one or more agents 112. Tracking system 102 may be configured to capture the motions of one or more agents (e.g., players) on the playing surface, as well as one or more other agents (e.g., objects) of relevance (e.g., ball, puck, referees, etc.). In some embodiments, tracking system 102 may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system (e.g., tracking system 102) may result in many different camera views of the playing surface (e.g., high sideline view, free-throw line view, huddle view, face-off view, end zone view, etc.).

In some embodiments, tracking system 102 may be used for a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). A game file 110 may be converted from a first format (e.g., a format output by the one or more cameras or a different format than the format output by the one or more cameras) and may be converted into a second format (e.g., for broadcast transmission).

In some embodiments, game file 110 may further be augmented with other event information corresponding to event data, such as, but not limited to, game event information (pass, made shot, turnover, etc.) and context information (current score, time remaining, etc.). Event data may be input via an event data input system and/or may be automatically identified using a machine learning model trained to receive, as an input, a game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with data store 118, discussed further herein.

Organization computing system 104 may be configured to process the broadcast stream of the game and generate and/or predict player index values for one or more players. Organization computing system 104 may include at least a web client application server 114, tracking data system 116, data store 118, play-by-play module 120, padding module 122, and/or prediction module 124. Each of tracking data system 116, play-by-play module 120, padding module 122, and prediction module 124 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

Tracking data system 116 may be configured to receive broadcast data from tracking system 102 and generate tracking data from the broadcast data. In some embodiments, tracking data system 116 may apply an artificial intelligence and/or computer vision system configured to derive player-tracking data from broadcast video feeds.

To generate the tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may re-identify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating tracking data from the broadcast feed (e.g., broadcast video data). For example, tracking data system 116 may perform such processes to generate tracking data across thousands of possessions and/or broadcast frames. In addition to such process, organization computing system 104 may go beyond the generation of tracking data from broadcast video data. Instead, to provide descriptive analytics, as well as a useful feature representation for prediction module 124, organization computing system 104 may be configured to map the tracking data to a semantic layer (e.g., events).

Tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize machine learning outputs and/or manually annotated data that may reflect the referee's ultimate adjudication. Such data may be referred to as the play-by-play feed. For example, play-by-play module 120 may receive video data from a broadcast video stream in a first format and convert the first format to a second format readable by the play-by-play module 120. The first format may include an information format (e.g., text, character strings, and/or video data) based on the manually inputted and/or automatically generated data. The second format may include a machine-readable format that may be provided as input to one or more machine-learning models. The second format may include, for example, a JSON file, XML file, or the like. The play-by-play module 120 may further convert data from the second format to a third format as box score data. The third format may include an information format (e.g., text, character strings, and/or video data) based on the automatically generated data from the play-by-play module 120.

To help identify events within the generated tracking data, tracking data system 116 may merge or align the play-by-play data with the raw generated tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, tracking data system 116 may use a measure referred to as an “influence score.” The influences score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

Padding module 122 may be configured to create new player representations using mean-regression to reduce random noise in the features. For example, one of the profound challenges of modeling using potentially only limited games (e.g., 20-30 games) of data per player may be the high variance of low frequency events seen in the tracking data. Therefore, padding module 122 may be configured to utilize a padding method, which may be a weighted average between the observed values and sample mean.

Accordingly, for each player, tracking data system 116, play-by-play module 120, and padding module 122 may work in conjunction to generate a raw data set and a padded data set for each player.

Prediction module 124 may be configured or trained to generate and/or predict player index values for each player. For example, prediction module 124 may be configured to receive the foregoing features (e.g., rookie priors, time series data points, player position data, box score data, play-by-play data, and the like) as inputs and run the inputs through gradient-boosted decision trees to generate a player index value for each player. Using the player index value, prediction module 124 may take each statistical output and predict a player's index value for future actions. The prediction module 124 may output one or more of a generated player index value, an average player index value, a predicted player index value, and a performance factor.

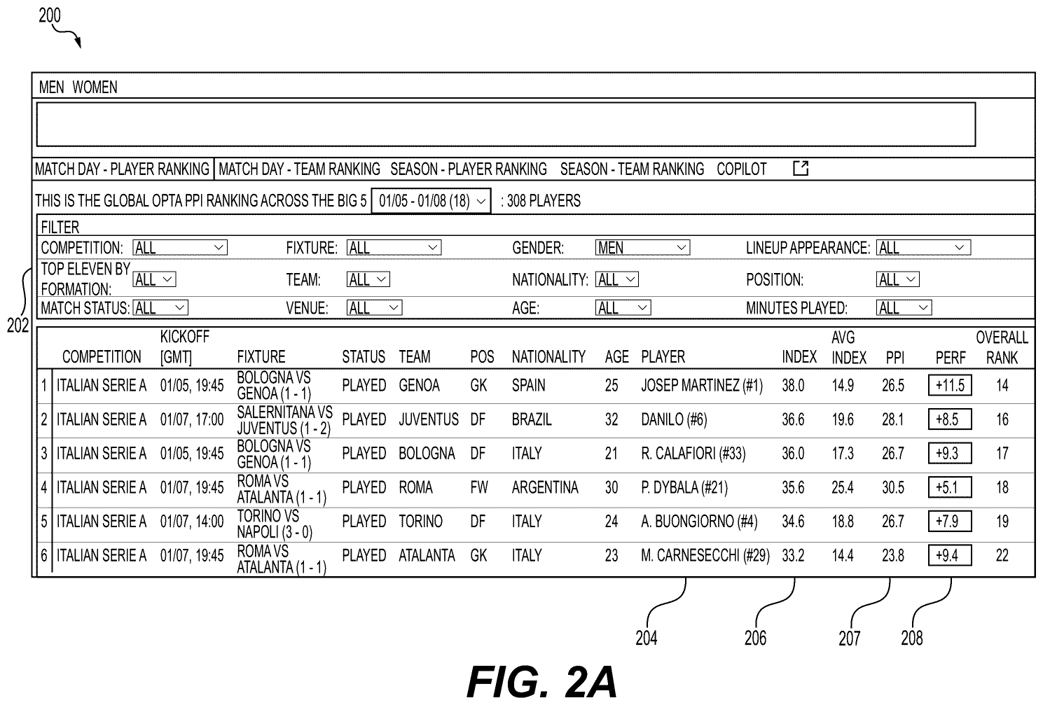

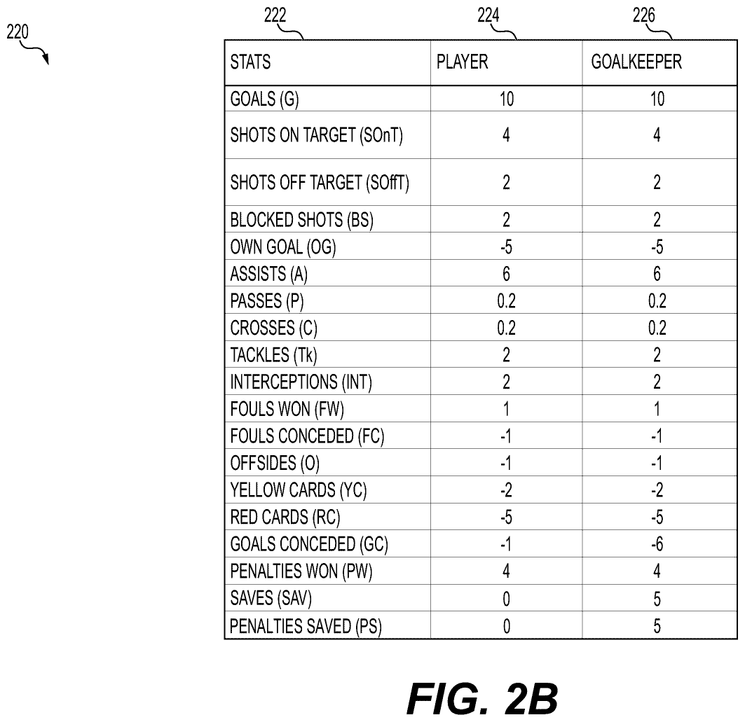

In some embodiments, prediction module 124 may include a separate prediction model tuned for each player. Given that all players are very different from each other, there are times that a prediction model may have trouble projecting their abilities. In such scenarios, projections from prediction module 124 may be compared with real-world or actual statistics. Using Steph Curry, for example, if prediction module 124 generates a three-point percentage for Curry that is below Curry's average three-point percentage, an operator may adjust the weights of Curry's individualized prediction model. Prediction module 124 is discussed further in conjunction with figures discussed below (e.g., FIGS. 2-4).

Data store 118 may be configured to store one or more game files 126. Each game file 126 may include video data of a given match. For example, the video data may correspond to a plurality of video frames captured by tracking system 102, the tracking data derived from the broadcast video as generated by tracking data system 116, play-by-play data, enriched data, and/or padded training data. Game files 126 may be based, for example, on game files 110 as discussed herein. Game files 126 may be in a different format than game files 110. For example, a first format of game files 110 or a subset thereof may be transformed into a second format of game files 126. The transformation may be performed automatically based on the type and/or content of the first format and the type and/or content of the second format.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 130. Application 130 may be representative of a web browser that allows access to a website or a stand-alone application. Client device 108 may access application 130 to access one or more functionalities of organization computing system 104. Client device 108 may communicate over network 105 to request a webpage, for example, from web client application server 114 of organization computing system 104. For example, client device 108 may be configured to execute application 130 to access one or more player index values generated by the prediction module 124. The content that is displayed to client device 108 may be transmitted from web client application server 114 to client device 108, and subsequently processed by application 130 for display through a graphical user interface (GUI) of client device 108.

### Example Prediction Engine

An example prediction engine (e.g., which may be part of a tracking data system) may be configured to predict an underlying formation of a team.

Mathematically, the goal of a role-alignment procedure may be to find the transformation A:{U₁, U₂, . . . , Uₙ}×M=>[R₁, R₂, . . . , R_{K}], which may map the unstructured set U of N player trajectories to an ordered set (e.g., a vector) of K role-trajectories R. Each player trajectory itself may be an ordered set of positions Uₙ=[x_{s,n}]ₛ₌₁^{S} for an agent n∈[1, N] and a frame s∈[1, S]. In some embodiments, M may represent the optimal permutation matrix that enables such an ordering. The goal of the prediction module 124 may be to find the most probable set of [symbol] * of two-dimensional (2D) probability density functions:

$${ℱ}^{*} = arg {max}_{ℱ} P ( ℱ \vert R )$$

$$P ( x ) = {\sum }_{n = 1}^{N} P ( x \vert n ) P ( n ) = \frac{1}{N} {\sum }_{n = 1}^{N} {P}_{n} ( x )$$

In some embodiments, this equation may be transformed into one of entropy minimization where the goal is to reduce (e.g., minimize) the overlap (e.g., the KL-Divergence) between each role. As such, in some embodiments, the final optimization equation in terms of total entropy H may become:

$${ℱ}^{*} = arg {max}_{ℱ} {\sum }_{n = 1}^{N} H ( x \vert n )$$

The prediction engine may include a formation discovery module, a role assignment module, a template module, and/or the like each corresponding to a distinct phase of the prediction process. The formation discovery module may be configured to learn the distributions which maximize the likelihood of the data. The role assignment module may be configured to map each player position to a “role” distribution in each frame. Once the data has been aligned, the template module may be configured to map each learned formation a formation cluster template.

An organization computing system may receive tracking data and/or event data for a plurality of events across a plurality of seasons or across a match. For each event, the pre-processing agent may divide the event into a plurality of segments based on the event information. In some embodiments, the pre-processing agent may divide the event into a plurality of segments based on various events that may occur throughout the game. For example, the pre-processing agent may divide the event into a plurality of segments based on one or more events that include, but may not be limited to, red cards, ejections, technical fouls, flagrant fouls, player disqualifications, substitutions, halves, periods, quarters, overtime, and the like. Generally, each segment of a plurality of segments associated with an event may include an interval of a requisite duration (e.g., at least one minute of play, at least two minutes of play, etc.). Such requisite duration may allow an organization computing system to detect a team's formation.

Each segment may include a set of tracking data associated therewith. The player tracking data may be captured by tracking system, which may be configured to record the (x, y) positions of the players at a high frame rate (e.g., 10 Hz). In some embodiments, the player tracking data may further include single-frame event-labels (e.g., pass, shot, cross) in each frame of player tracking data. These frames may be referred to as “event frames.” As shown, the initial player tracking data may be represented as a set U of N player trajectories. Each player trajectory itself may be an ordered set of positions Uₙ=[x_{s,n}]ₛ₌₁^{S} for an agent n∈[1, N] and a frame s∈[1, S].

In some embodiments, the pre-processing agent may normalize the raw position data of the players. For example, the pre-processing agent may normalize the raw position data of the players in each segment so that all teams in the player tracking data are attacking from left to right and have zero mean in each frame. Such normalization may result in the removal of translational effects from the data. This may yield the set U′={U′₁, U′₂, . . . , U′ₙ}.

In some embodiments, the pre-processing agent may initialize cluster centers of the normalized data set for formation discovery with the average player positions. For example, average player positions may be represented by the set μ₀={μ₁, μ₂, . . . , μ₃}. The pre-processing agent may take the average position of each player in the normalized data and may initialize the normalized data based on the average player positions. Such initialization of the normalized data based on average player position may act as initial roles for each player to minimize data variance.

An organization computing system may learn a formation template from the tracking data for each segment. For example, the formation discovery module may learn the distributions which maximize the likelihood of the data. The formation discovery module may structure the initialized data into a single (SN)×d vector, where S may represent the total number of frames, N may represent the total number of agents (e.g., ten outfielders in the case of soccer, five players in the case of basketball, fifteen players in the case of rugby, etc.) and d may represent the dimensionality of the data (e.g., d=2).

The formation discovery module may then initiate a formation discovery algorithm. For example, the formation discovery module may initialize a K-means algorithm using the player average positions and execute to convergence. Executing the K-means algorithm to convergence produces better results than conventional approaches of running a fixed number of iterations.

The formation discovery module may then initialize a Gaussian Mixture Model (GMM) using cluster centers of the last iteration of the K-means algorithm. By parametrizing the distribution as a mixture of K Gaussians (with K being equal to the number of “roles,” which is usually also equal to N, the number of players), the formation discovery module may be able to identify an optimal formation that maximizes the likelihood of the data x. In other words, GMM may be configured to identify [symbol] *={P₁, P₂, . . . , P_{K}}, where [symbol] * may represent the optimal formation that maximizes the likelihood of the data x. Therefore, instead of stopping the process after the last iteration of the K-means algorithm, the formation discovery module may use GMM clustering, as the ellipse may better capture the shape of each player role compared to only a K-means clustering technique, which captures the spherical nature of each role's data cloud.

Further, GMMs are known to suffer from component collapse and become trapped in pathological solutions. Such collapse may result in non-sensible clustering, e.g., non-sensical outputs that may not be utilized. To combat this, the formation discovery module may be configured to monitor eigenvalues (At) of each of the components or parameters of the GMM throughout the expectation maximization process. If the formation discovery module determines that the eigenvalue ratio of any component becomes too large or too small, the next iteration may run a Soft K-Means (e.g., a mixture of Gaussians with spherical covariance) update instead of the full-covariance update. Such process may be performed to ensure that the eventual clustering output is sensible. For example, the formation discovery module may monitor how the parameters of the GMM are converging; if the parameters of the GMM are erratic (e.g., “out of control”), the formation discovery module may identify such erratic behavior and then slowly return the parameters back within the solution space using a soft K-means update.

It will be understood that a prediction engine and/or related components may be implemented using techniques alternative or in addition to those described herein.

### Hash-Table/Playbook Learning

For retrieval tasks using large amounts of data, an example embodiment of the system uses a hash-table is required by grouping similar plays together, such that when a query is made, only the “most-likely” candidates are retrieved. Comparisons can then be made locally amongst the candidates and each play in these groups are ranked in order of most similar. Previous systems attempted clustering plays into similar groups by using only one attribute, such as the trajectory of the ball. However, the semantics of a play are more accurately captured by using additional information, such as information about the players (e.g., identity, trajectory, etc.) and events (pass, dribble, shot, etc.), as well as contextual information (e.g., if team is winning or losing, how much time remaining, etc.). Thus, embodiments of the present system utilize information regarding the trajectories of the ball and the players, as well as game events and contexts, to create a hash-table, effectively learning a “playbook” of representative plays for a team or player's behavior. The playbook is learned by choosing a classification metric that is indicative of interesting or discriminative plays. Suitable classification metrics may include predicting the probability of scoring in soccer or basketball (e.g., expected point value (“EPV”), or expected goal value (“EGV”). Other predicted values can also be chosen for performance variables, such as probability of making a pass, probability of shooting, probability of moving in a certain direction/trajectory, or the probability of fatigue/injury of a player.

The classification metric is used to learn a decision-tree, which is a coarse-to-fine hierarchical method, where at each node a question is posed which splits the data into groups. A benefit of this approach is that it can be interpretable and is multi-layered, which can act as “latent factors.”

### Example Bottom-Up Approach

In an embodiment of the system, an example bottom-up approach to learning the decision tree is used. Various features are used in succession to discriminate between plays (e.g., first use the ball, then the player who is closest to the ball, then the defender etc.). By aligning the trajectories, there is a point of reference for trajectories relative to their current position. This permits more specific questions while remaining general (e.g., if a player is in the role of “point guard”, what is the distance from his/her teammate in the role of “shooting guard”, as well as the distance from the defender in the role of “point guard”). Using this approach avoids the need to exhaustively check all distances, which is enormous for both basketball and soccer.

### Example Top-Down Approach

In another embodiment of the system, an example top-down approach to learning the decision tree is used. At a first step, all the plays are aligned to the set of templates. From this initial set of templates, the plays are assigned to a set of K groups (clusters), using all ball and player information, forming a Layer 1 of the decision tree. Back propagation is then used to prune out unimportant players and divide each cluster into sub-clusters (Layer 2). The approach continues until the leaves of the tree represent a dictionary of plays which are predictive of a particular task—e.g., goal-scoring (Layer 3).

### Personalization Using Latent Factor Models

In addition to raw trajectory information, in embodiments of the system, the plays in the database are also associated with game event information and context information. The game events and contexts in the database for a play may be inferred directly from the raw positional tracking data (e.g., a made or missed basket), or may be manually entered. Role information for players (can also be either inferred from the positional tracking data or entered separately. In embodiments of the system, a model for the database can then be trained by crafting features which encode game specific information based on the positional and game data and then calculating a prediction value (between 0 and 1) with respect to a classification metric (e.g., expected point value).

If there are a sufficient number of examples, the database model can be personalized for a particular player or game situation using those examples. In practice, however, a specific player or game situation may not be adequately represented by plays in the database. Thus, embodiments of the system find examples which are similar to the situation of interest-whether that be finding players who have similar characteristics or teams who play in a similar manner. A more general representation of a player and/or team is used, whereby instead of using the explicit team identity, each player or team is represented as a distribution of specific attributes. Embodiments of the system use the plays in the hash-table/playbook that were learned through the distributive clustering processes described above.

Further, while various aspects are discussed with respect to a single sport, such aspects are described are merely illustrative examples. Disclosed techniques are by no means limited to any sport in particular. For example, the present aspects can be implemented for other sports or activities, such as soccer, football, basketball, baseball, hockey, cricket, rugby, tennis, and so forth.

FIG. 2A depicts an exemplary graphical user interface 200 incorporating the interactive display. As described above, the interactive display may be generated by a display generation module, such as that described with respect to FIG. 1 above. As illustrated in FIG. 2A, the displayed data may have filters 202 applied to alter the interactive display (e.g., as displayed by graphical user interface 200). The interactive display may include a player name 204 and the generated unique index 206. Additionally, a predicted player index 207 and a performance factor 208 may be generated using the unique index 206, and may be displayed, as illustrated. Further, as the user interacts with the interactive display, a graphical representation of the one or more event actions associated with the unique identifier and/or a graphical representation of the plurality of weights applied to the one or more event actions may also be displayed.

Unique index 206 may be generated in real time based on event data received at and/or generated by organization computing system 104. The event data may be automatically parsed upon receipt, such that player event actions for each applicable player are extracted from the event data. According to embodiments, event data may be generated manually or may be generated by a computing system in real time (e.g., within approximately 30 seconds of an event occurring), as discussed herein. A computing system may generate the event data by, for example, analyzing tracking data (e.g., from tracking system 102), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession based event, play type event, etc.). Respective weights may automatically applied to the player event actions to generate action index values. The action index values may be aggregated to generate the player index for a given player.

In order to generate the player index in real time, event data received at and/or generated by organization computing system 104 may be transformed from a first format to a second format that separates each event action from the event data. The separation may include identifying and/or categorizing each event action based on a corresponding applicable action index (e.g., goal scored, passes, etc.). Such separation may be performed by a system or machine learning model trained to identify and/or categorize event actions based on tags, values, and/or attributes associated with each event action. The separation may result in the event data being provided in a second format to which weights can be applied instantly (e.g., in real time). Event actions that do not correspond to an action index may be discarded (e.g., not used) such that reduced resources are expended to generate the index values associated with a subset of the event data. Such non-applicable event actions may be removed from a file having the second format and/or may be tagged as not applicable.

According to embodiments, graphical user interface 200 may be updated in real time based on one or more factors such as unique index 206, changes in unique index 206, predicted player index 207, performance factor 208 and/or the like. For example, graphical user interface 200 may be ordered such that a player with the highest or lowest player index is displayed towards the top or bottom of a player list of graphical user interface 200. Such an order may be adjusted based on changes the unique index 206 for the respective players included in graphical user interface 200.

According to embodiments, graphical user interface 200 may be updated such that the order or players provided above may be based on user preferences or user profile information. A user profile may include user preferences including prior use of the graphical user interface 200 by a given user, based on prior use of the graphical user interface 200 by a cohort of users, and/or the like. An ordering machine learning model may be trained based on historical or simulated use of graphical user interface 200 by a given user or a cohort of users, in accordance with the techniques disclosed herein. The ordering machine learning model may output an order in which the players and corresponding players are listed at graphical user interface 200.

According to embodiments, graphical user interface 200 may be updated such that additional graphics may be displayed. For example, each player name may also include a thumbnail image associated therewith. In addition, the data displayed within graphical user interface 200 may be presented to a third-party application. For example, a third-party application may receive the generated player data for use in an interactive story or stream for a team and/or an individual player. In addition, broadcasters may use the generated player index information for comment during live broadcast events of the match.

Predicted player index 207 may be output by a prediction machine learning model (e.g., prediction module 124) and may provide a predicted player index value based on one or more outputs from a player props foundation model, which may use one or more transformer based models. The outputs from the player props foundation model may include predictions for one or more individual players and/or teams. The one or more outputs statistics for an individual player may include the number of goals, passes, shots, interceptions, or the like. The predicted player index 207 may be generated using one or more outputs from the player props foundation model and/or additional features (e.g., rookie priors, time series data points, player position data, box score data, play-by-play data, and the like) as inputs and run the inputs through a transformer based graph neural network (GNN). In addition, upcoming match-ups may be used in generating a predicted player index 207. For example, the predicted player index 207 may be generated using statistics associated with individual players and the team for an upcoming match-up. Depending on if a player has performed better or worse against a specific team, the predicted player index 207 may be higher or lower. Likewise, if the team for the upcoming match-up has performed better or worse recently, the predicted player index 207 may additionally be affected.

The predicted player index 207 may be modified for each player separately based on dynamically receiving updated information associated with each player. For example, when new data is available for a player based on a live match, the prediction module 124 may receive the new information to generate a modified predicted player index 207 for display. The predicted player index 207 may be continuously updated when data is available.

A performance factor 208 may describe the difference between the unique index 206 and the predicted player index 207. For example, as shown in FIG. 2A, Joseph Martinez has a unique index 206 of 38.0 and a predicted player index 207 of 26.5. To determine the performance factor 208, the predicted player index 207 is subtracted from the unique index 206 (e.g., 38.0−26.5) giving you the performance factor 208 (e.g., +11.5).

As similarly described above with respect to individual players, the unique index 206, predicted player index 207, and the performance factor 208 may be generated for individual teams.

FIG. 2B depicts a table 220 of action index values 224 and 226 associated with corresponding event actions 222. As shown in table 220, a given event action 222 may have a corresponding positive or negative action index values 224 and 226. Such action index values may not be binary, as shown, such that a more comprehensive index may be generated in comparison to one having only binary values (e.g., goal scored or not scored). Event data may be categorized based on the event actions 222 (e.g., in the second format discussed herein). As shown via action index values 224 and 226, different positions of players may have different action index values. For example, in reference to a soccer sporting event, actions of a non-goalkeeper player may be indexed based on action index values 224 and at least a subset of the same actions performed by goalkeeper may be indexed based on action index values 226.

As shown, a plurality of even actions may be used to generate a player index such that index values associated with the event actions may change frequently throughout a sporting event for a user to see index changes throughout the sporting event. Such changes may create re-engagement which may be relevant for potential subsequent actions such as those related to odds based activity. The event actions may change at a slow enough frequency such that odds based activity may be possible.

Action index values 224 and 226 may remain consistent across players, sporting events, a given sport, and/or across multiple seasons of the given sport. According to an embodiment, action index values 224 and 226 may be output by an index machine learning model trained based on historical or simulated event actions, predictions in view of such historical or simulated event actions, outcomes resulting from such historical or simulated event actions, and/or the like. The output of the index machine learning model may be used to generate action index values 224 and 226.

Updates to event actions 222 and/or action index values 224 and 226 (e.g., as may be output by an index machine learning model) may trigger an alert. The alert may be provided to all users of graphical user interface 200 to maintain transparency of the player index values. The alert may be generated to include the update, the prior event actions 222 and/or action index values 224 and 226, the updated event actions 222 and/or action index values 224 and 226, and/or the like. Each event action 222 may be different from sport to sport. In some embodiments, event action 222 may be the same between different sports, however, each event action may include a different weight, for example, a goal in soccer may include a weight of 10 plus an additional +4 for the shot, whereas a goal in handball may include a weight of 4. For example, a player may have 2 goals, 10 passes and 1 offside, generating an index of 29 (e.g., 2*10 (goal)+2*4 (shot on target)+10*0.5 (passes)+1*−1 (offsides)). If the player were to increase their passes from 10 to 11, the index would increase to 29.2 accordingly.

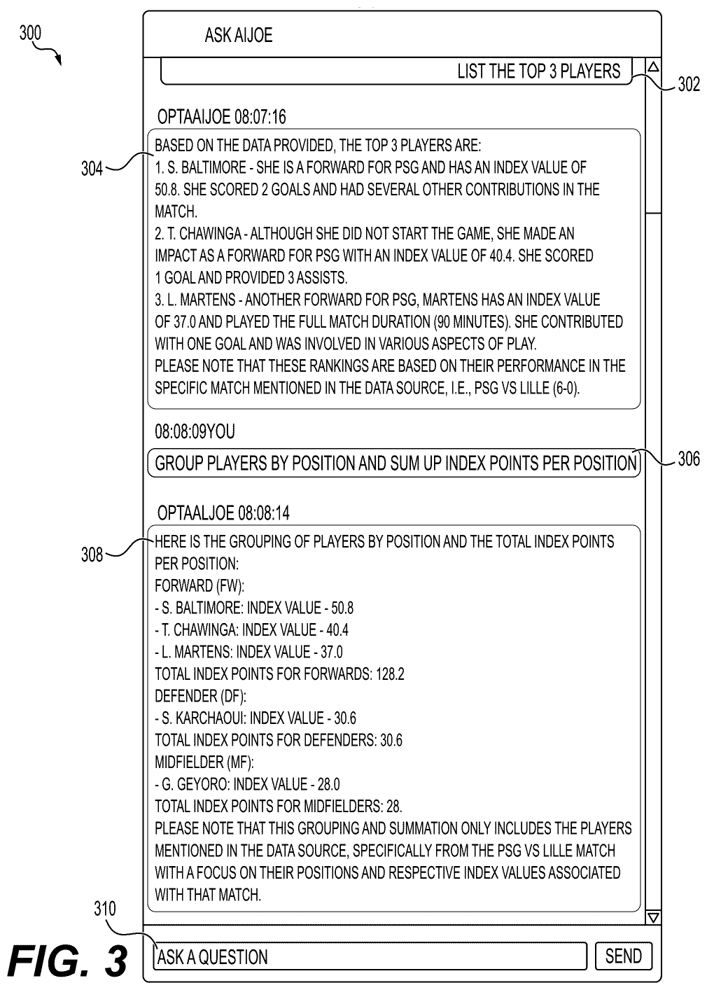

FIG. 3 depicts an exemplary graphical user interface 300 implemented using a generative machine learning model. As illustrated, a user may pose (e.g., input) a question or first input 302 into the graphical user interface 300 via input box 310. An generative machine learning model trained to process natural language (e.g., a language learning model) may thereby process the first input 302 using natural language processing and data captured, generated, or stored, by the computing system (e.g., organization computing system 104 as depicted in FIG. 1), to generate a first response 304 that may be displayed in the graphical user interface 300. The first response 304 may be formatted in natural language that can be generally understood, and may utilized event data captured using organization computing system 104 or other components separate from environment 100 (as depicted in FIG. 1). As illustrated, the user may pose a second question, or second input 306, and the artificial intelligent model may generate a second response 308.

For example, a first input 302 may be received at graphical user interface 300. A generative machine learning model may receive the first input 302 as an input. The generative machine learning model may be iteratively trained based training data such as the event data received at or generated by organization computing system 104, the player name 204, player index 206, performance factor 208, and/or an overall rank of a given player. Based on the training data, which may be updated in real time, the generative machine learning model may output a natural language response to the first input 302. The natural language response may be generated by, first, generating numerical values in response to the first input 302 and, second, converting the numerical values into the natural language response. Accordingly, the natural language model may be trained on sporting event data such that its output is specific to the sporting even data.

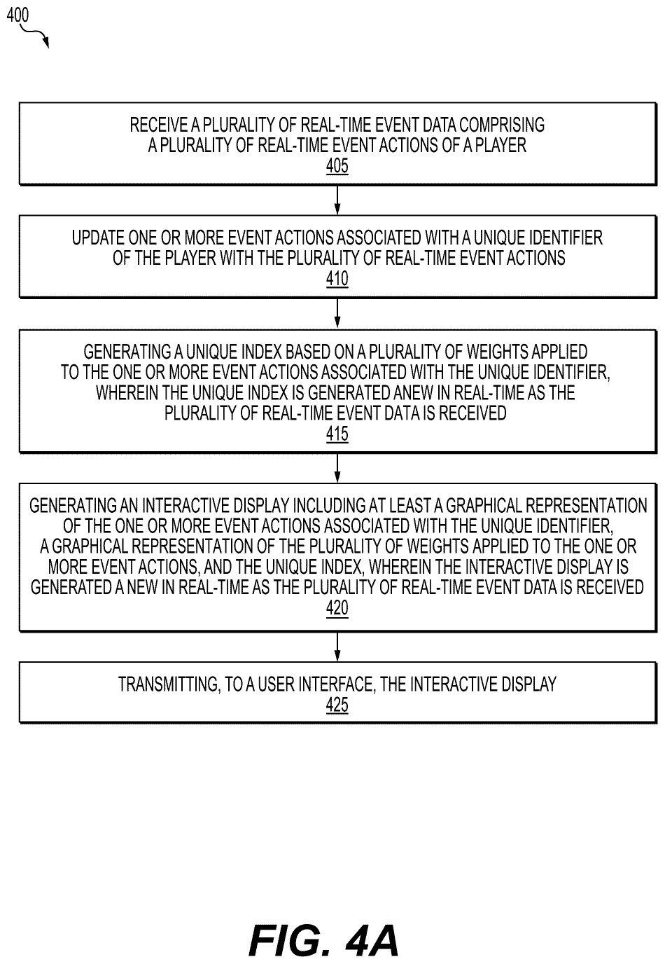

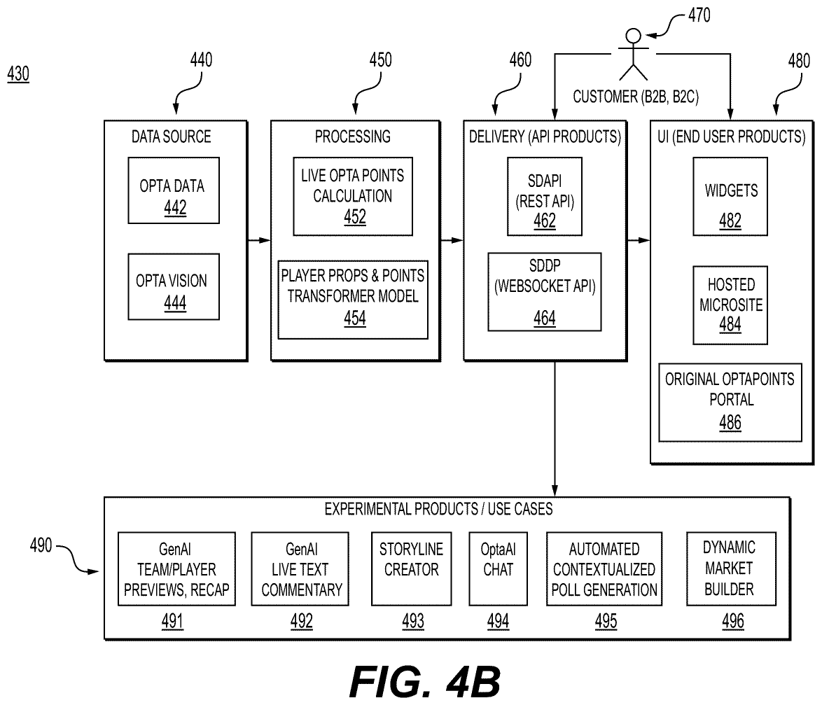

FIG. 4A illustrates an exemplary method 400 for generating an interactive display. Exemplary method 400 begins with step 405, wherein a plurality of real-time event data comprising a plurality of real-time event actions of a player are received (e.g., by organization computing system 104 as depicted in FIG. 1). The plurality of real-time event actions of the player may include one or more event actions 222 such as, for example, a scored goal, a completed pass, an interception, a goal conceded, or the like. The plurality of real-time event actions may be received from automatically generated tracking data and/or event data that is generated based on in-venue or broadcast feeds. For example, tracking data system 116 may be configured to receive information from tracking system 102 location within venue 106 and/or in communication with components within venue 106. The information received may be utilized by tracking data system 116 to automatically generate tracking data and/or event data. At step 410, one or more event actions associated with a unique identifier of a player associated with the plurality of real-time event actions are updated. Accordingly, at step 410, the event data received at step 405 may be associated with one or more corresponding players. At step 415, a unique index is generated based on a plurality of weights applied to the one or more event actions associated with the unique identifier (e.g., by prediction module 124 as depicted in FIG. 1 and table 220 depicted in FIG. 2B). The plurality of weights may be applied to the one or more event actions according to a set of rules. In examples, the unique index is generated in real-time as the plurality of real-time event data is received. As described above, the unique index may be provided to an artificial intelligence or machine-learning model as input to predict a player's performance or to respond to user questions.

At step 420, an interactive display is generated that includes at least a graphical representation of the one or more event actions associated with the unique identifier, a graphical representation of the plurality of weights applied to the one or more event actions, and the unique index (e.g., by web client application server 114 as depicted in FIG. 1). In examples, the interactive display is generated in real-time as the plurality of real-time event data is received. The interactive display may be generated according to a set of ordering rules. In examples, the ordering rules may include a first ordering rule. The first ordering rules may include displaying a first unique index above a second unique index in the interactive display based on the first unique index including a higher numerical value relative to the second unique index. Further, the interactive display may be configured to be filtered according to one or more of the unique index or unique identifier. At step 425, the interactive display is transmitted to a user interface (e.g., via network 105 to a display of client device 108 via application 130, as depicted in FIG. 1).

FIG. 4B illustrates an exemplary block diagram 430 for generating an interactive display. Block diagram 430 may include data source 440, processing 450, delivery 460 (API products), customer 470, user interface (UI) 480, and experimental products 490. Data source 440 may include Opta data 442 and Opta Vision 444. The term “Opta” may refer to a service that offers real-time data, analysis, and/or insights that may be used by other components. Opta data 442 may be a storage repository configured to store data for use by one or more components of a computing environment (e.g., computing environment 100). Opta data 442 may include data from hundreds of competitions and matches from thousands of players globally. Opta Vision 444 may be configured to automatically collect data utilizing a combination of computer vision and generative Al techniques. Opta Vision 444 may provide dynamic XY field locations for all players within a match, uninterrupted from start to finish. For example, Opta Vision 444 may be configured to collect data from a broadcast feed. The collected data from the broadcast feed may be used to generate tracking data and event data (e.g., third man run, change in direction in a game, or the like).

The processing step 450 may include live Opta points calculation 452 and player props and points transformer model 454. Processing 450 may be configured to receive and process data stored in data source 440. Live Opta points calculation 452 may be configured to quantify a player's contribution in real-time or near real-time. For example, live Opta points calculation may determine a metric by combining 19 data points and features into a single transparent score, this may be calculated using data from Opta data 442. Player props and points transformer model 454 may be one or more machine learning models configured to transform each player prop and points into a format recognizable by processing 450 (e.g., first format) and/or transform each of the player props and points into a format recognizable by delivery 460 (e.g., second format).

Delivery 460 may be configured to receive information from processing 450 and deliver each data item to one or more APIs. Delivery 460 may include a script debugger (SD) API 462 (e.g., REST API) and simple service discovery protocol (SDDP) API 464 (e.g., Websocket API). SD API 462 may be configured to retrieve, modify, and/or delete data transmitted between applications. SDDP API may be configured to provide a two-way interactive communication session between a user's browser and a server.

UI 480 may be configured to display information on a user device (e.g., client device 108). UI 480 may include widgets 482, hosted microsite 484, and Opta points portal 486. Widgets 482 may include one or more software components and/or applications to display information allowing a user (e.g., customer 470) to interact with an application or operating system. For example, widget 482 may provide an interface for interacting with information calculated by processing 450. UI 480 may provide an interface for customer 470 to interact with player data and provide feedback to processing 450 through delivery 460 via SDDP API 464. UI 480 may be configured to allow customer 470 to interact with one or more pages, for example, Hosted microsite 484 and Opta points portal 486.

Experimental products 490 may include GenAI previews 491, GenAI text commentary 492, storyline creator 493, OptaAI chat 494, automated contextualization 495, and dynamic market builder 496. GenAI previews 491 may be configured to receive information from processing 450 and/or customer 470 via delivery 460 to generate one or more previews, insights, and/or recaps of previous match, team, and/or player, as well as predications for upcoming matches. GenAI previews 491 may include one or more machine learning models trained to generate the one or more previews, insights, and/or recaps. The information displayed through GenAI previews 491 may be integrative through UI 480. Customer 470 may interact with the information provided by GenAI previews 491 and based on the interaction, GenAI preview 491 may be dynamically updated. For example, if GenAI preview 491 displays a preview of an upcoming match (e.g., Liverpool FC vs. Manchester United FC) a customer 470 may select one or more players associated with the preview to see additional information. Based on the customer 470 interaction, GenAI preview 491 may dynamically update to provide additional insights (e.g., predictions, matchups, etc.) for each selected player.

GenAI text commentary 492 may be configured to provide text commentary during live broadcast feeds of a match or competition. GenAI text commentary 492 may utilize information provided from data source 440 with identified tracking data and/or event data providing contextualization for each data point received. GenAI text commentary 492 may be provided to a customer 470 via UI 480. The customer 470 may interact with UI 480, as similarly described above. For example, GenAI text commentary 492 may provide play-by-play information of a live match to a customer 470 via UI 480 in a news feed format.

Storyline creator 493 may be configured to generate storyline and/or stories of past, present, and upcoming matches as well as insights for player profiles. The stories may include an engaging interface providing visual and interactive content and graphics. The interactive content may include lineups, recaps/summaries, and predictions for teams, matches, and players. For example, the interactive content may be utilized by broadcasters to generate stories of a portion of the live match to summarize the events of the match so far. In addition, customer 470 may utilize the interactive content to generate a story based on a selected player and/or team to be posted on their respective social media account. The interactive content may be customizable for each user based on their respective user preference and/or user profile.

OptaAI chat 494 may be an automated messaging system configured to request information and/or provide feedback to a user (e.g., customer 470). OptaAI chat 494 may be configured to receive inputs (e.g., text, character strings, images, video, and audio) from a user to perform one or more tasks. For example, a user may request via text input the play-by-play information relating to a recent match between Liverpool FC vs. Manchester United FC. In addition, a user may request OptaAI chat 494 to generate a story using storyline creator 493 including highlights of their favorite player. OptaAI chat 494 may be configured to receive and transmit information between other components of block diagram 430 based on the inputs received from a user.

Automated contextualization 495 may be configured to generate contextual information relating to information stored in data source 440 to create interactive polls. Automated contextualization 495 may receive data from data source 440 and generate context for each piece of data (e.g., player statistics, team statistics, etc.). Upon generating context data, automated contextualization 495 may generate one or more interactive polls for display via UI 480 to a user (e.g., customer 470). The user may then interact with the interactive poll provided allowing automated contextualization 495 to receive additional information to provide a dynamically updated poll.

Dynamic market builder 496 may be configured to dynamically generate one or more bets based on insights provided by processing step 450. For example, dynamic market builder 496 may receive outputs generates by Opta points calculation 452 and player props and points transformer model 454 and determine one or more bets. The bets may be based on pre-match and in-play statistics. Dynamic market builder 496 may be customizable for each user based on their respective user preferences and/or user profiles. The customized bets may allow for more efficient discovery of bets that suit the individual user. For example, a user may place a market prediction on a single team or player on a regular basis. Dynamic market builder 496 may provide one or more potential market prediction options relating to the team and/or player to the user prior to an upcoming match. This allows the user to more efficiently find and utilize the bets they may engage in or consistently search for prior to each match.

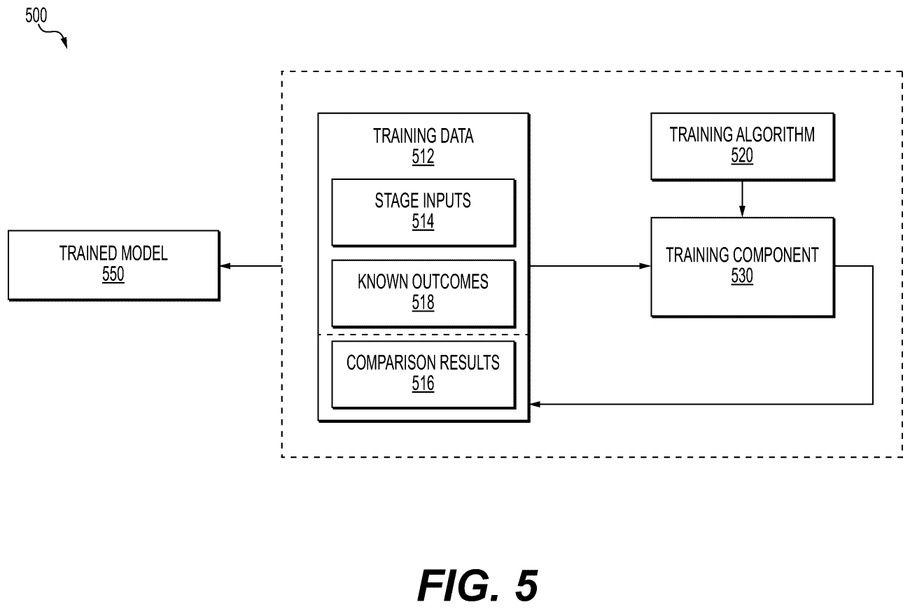

FIG. 5 depicts a flow diagram for training a machine learning model, in accordance with an aspect of the disclosed subject matter. As shown in flow diagram 500 of FIG. 5, training data 512 may include one or more of stage inputs 514 and known outcomes 518 related to a machine learning model to be trained. The stage inputs 514 may be from any applicable source including a component or set shown in the figures provided herein. The known outcomes 518 may be included for machine learning models generated based on supervised or semi-supervised training. An unsupervised machine learning model might not be trained using known outcomes 518. Known outcomes 518 may include known or desired outputs for future inputs similar to or in the same category as stage inputs 514 that do not have corresponding known outputs.

The training data 512 and a training algorithm 520 may be provided to a training component 530 that may apply the training data 512 to the training algorithm 520 to generate a trained machine learning model 550. According to an implementation, the training component 530 may be provided comparison results 516 that compare a previous output of the corresponding machine learning model to apply the previous result to re-train the machine learning model. The comparison results 516 may be used by the training component 530 to update the corresponding machine learning model. The training algorithm 520 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 500 may be a trained machine learning model 550.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

### Machine Learning for Team/Player Predictions

According to embodiments disclosed herein, a transformer neural network may receive inputs (e.g., tensor layers), where each input corresponds to a given player, team, or game. The transformer neural network may output generated predictions for one or more given players or teams based on such inputs. More specifically, the transformer neural network may output such generated predictions for a given player or team based on inputs associated with that given player or team and further based on the influence of one or more other players or teams. Accordingly, predictions provided by a transformer neural network, as discussed herein, may account for the influence of multiple players and/or teams when outputting a prediction for a given player and/or team.

The system described herein may include a machine learning system configured to generate one or more predictions. In some examples, the system may incorporate a transformer neural network, graphical neural network, a recurrent neural network, a convolutional neural network, and/or a feed forward neural network. The system may implement a series of neural network instances (e.g., feed forward network (FFN) models) connected via a transformer neural network (e.g., a graph neural network (GNN) model). Although a transformer neural network is generally discussed herein, it will be understood that any applicable GNN, or other neural network that may utilize graphical interpretations, may be used to perform the techniques discussed herein in reference to a transformer neural network.

The system described herein may include a machine-learning model including a Long Short Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive text as input, and generate a response in real-time.

The transformer-based neural network may include a set of linear embedding layers, a transformer encoder, and a set of fully connected layers. The set of linear embedding layers may map component tensors of received inputs into tensors with a common feature dimension. The transformer encoder may perform attention along the temporal and agent dimensions. The set of fully connected layers may map the output embeddings from a last transformer layer of the transformer encoder into tensors with requested feature dimension of each target metric.

The transformer-based neural network may be configured to receive input features through the set of linear embedding layers. The input features may be received at different resolutions and over a time-series. The input features may relate to player features, team features, and/or game features. Input features may be input into the linear embedding layers as a tuple of input tensors. For example, a tuple of three tensors may be provided where the first tensor corresponds to all players in a match, a second tensor corresponds to both teams in the match, and the third tensor corresponds to a match state.

Examining the set of linear embedding layers, the linear embedding layers may contain a linear block for each input tensor of the tuple, and each block may map an input tensor to a tensor with a common feature dimension D. The output of the linear embedding layer may be a tuple of tensors, with a common feature dimension, which can be concatenated along the temporal and agent dimension to form a single tensor.

The transformer encoder may be configured to receive the single tensor from the linear embedding layers. The transformer encoder may be configured to learn an embedding that is configured to generate predictions on multiple actions for each agent (e.g., each player and/or team). The transformer encoder may include a series of axial transformer encoder layers, where each layer alternatively applies attention along the temporal and agent dimensions. The transformer encoder may include layers that alternate between temporally applying attention to sequences of action events, and applying attention spatially across the set of players and teams at each event time-step. The transformer encoder may include axial encoder layers configured to accept a tensor from the linear layers and apply attention along the temporal dimension, then along the agent dimension.

The attention mechanism that is implemented by the transformer encoder layers may have a graphical interpretation on a dense graph where each element is a node, and the attention mask is the inverse of the adjacency matrix defining the edges between the nodes (the absence of an attention mask thus implies a fully-connected graph). In the case of the axial attention used here, with the attention mask on the temporal (row) dimension, the nodes in the graph can be arranged in a grid, and each node may be connected to all nodes in the same column, and to all previous nodes in the same row. Attention, in this case, may be message-passing where each node can accept messages describing the state of the nodes in its neighborhood, and then update its own state based on these messages. This attention scheme may mean that when making a prediction for a particular player, the model may consider (i.e. attend to): the nodes containing the previous states of the player along the time-series; and the state nodes of the other players, team and the current game state in the current time-step. It may not be necessary for the nodes to be homogeneous—beyond having the same feature dimension—and thus a node that represents a player can accept messages from a node that represents at team, or from the player's strength node. The model may therefore learn the interactions between agents, and ensure consistent predictions for each agent along the time-series. The output of the transformer encoder layers may be a tensor (e.g., an output embedding).

The final layers of the transformer-based neural network may be the fully connected layers. These layers may map the output embedding of the final transformer layer of the transformer encoder to the feature dimension of each target metric. The final layers may output a target tuple that contains tensors for each of a set of modeled actions for each player and/or team. For example, the modeled action may be an empirical estimate of distributions for sport statistics such as number of shots taken, number of goals, number of passes, etc.

The training of the transformer-based neural network may include choosing a corresponding loss function for the distribution assumption of each output target. For example, the loss function may be the Poisson negative log-likelihood for a Poisson distribution, binary cross entropy for a Bernoulli distribution, etc. The losses may be computed during training according to the ground truth value for each target in the training set, and the loss values may be summed, and the model weights may be updated from the total loss using an optimizer. The learning rate may have been adjusted on a schedule with cosine annealing, without warm restarts.

### Sports Machine Learning

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

### Machine Learning Models.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

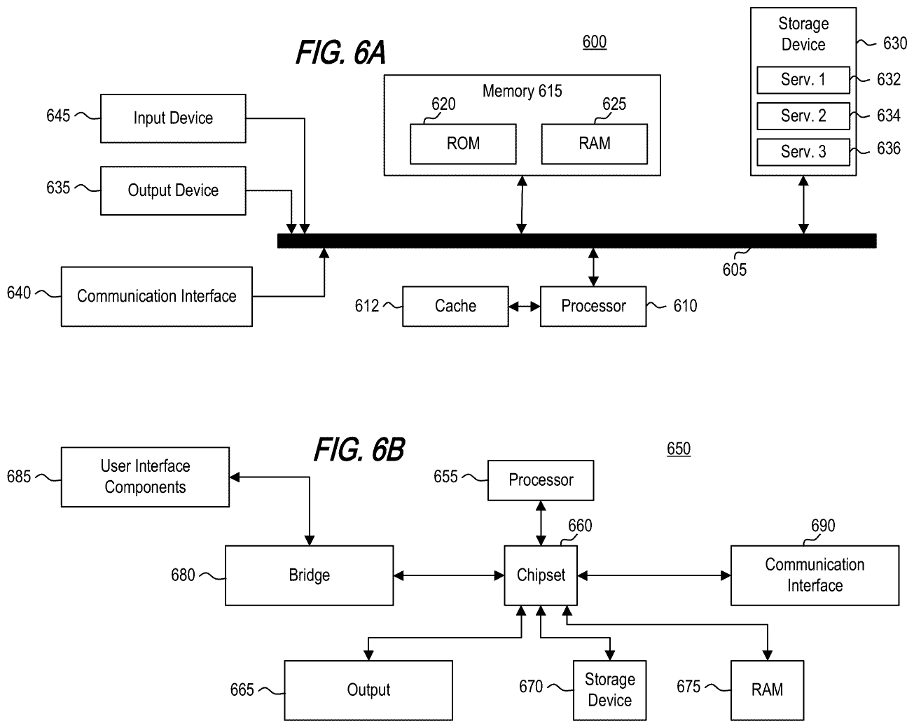

FIG. 6A illustrates an architecture of computing system 600, according to example embodiments. System 600 may be representative of at least a portion of organization computing system 104. One or more components of system 600 may be in electrical communication with each other using a bus 605. System 600 may include a processing unit (CPU or processor) 610 and a system bus 605 that couples various system components including the system memory 615, such as read only memory (ROM) 620 and random access memory (RAM) 625, to processor 610. System 600 may include a cache of high-speed memory connected directly with, in close proximity to, or integrated as part of processor 610. System 600 may copy data from memory 615 and/or storage device 630 to cache 612 for quick access by processor 610. In this way, cache 612 may provide a performance boost that avoids processor 610 delays while waiting for data. These and other modules may control or be configured to control processor 610 to perform various actions. Other system memory 615 may be available for use as well. Memory 615 may include multiple different types of memory with different performance characteristics. Processor 610 may include any general purpose processor and a hardware module or software module, such as service 1 632, service 2 634, and service 3 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction with the computing system 600, an input device 645 may represent any number of input mechanisms, such as a microphone for speech, a touch-sensitive screen for gesture or graphical input, keyboard, mouse, motion input, speech and so forth. An output device 635 (e.g., display) may also be one or more of a number of output mechanisms known to those of skill in the art. In some instances, multimodal systems may enable a user to provide multiple types of input to communicate with computing system 600. Communications interface 640 may generally govern and manage the user input and system output. There is no restriction on operating on any particular hardware arrangement and therefore the basic features here may easily be substituted for improved hardware or firmware arrangements as they are developed.

Storage device 630 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 625, read only memory (ROM) 620, and hybrids thereof.

Storage device 630 may include services 632, 634, and 636 for controlling the processor 610. Other hardware or software modules are contemplated. Storage device 630 may be connected to system bus 605. In one aspect, a hardware module that performs a particular function may include the software component stored in a computer-readable medium in connection with the necessary hardware components, such as processor 610, bus 605, output device 635, and so forth, to carry out the function.

FIG. 6B illustrates a computer system 650 having a chipset architecture that may represent at least a portion of organization computing system 104. Computer system 650 may be an example of computer hardware, software, and firmware that may be used to implement the disclosed technology. System 650 may include a processor 655, representative of any number of physically and/or logically distinct resources capable of executing software, firmware, and hardware configured to perform identified computations. Processor 655 may communicate with a chipset 660 that may control input to and output from processor 655. In this example, chipset 660 outputs information to output 665, such as a display, and may read and write information to storage device 670, which may include magnetic media, and solid-state media, for example. Chipset 660 may also read data from and write data to RAM 675. A bridge 680 for interfacing with a variety of user interface components 685 may be provided for interfacing with chipset 660. Such user interface components 685 may include a keyboard, a microphone, touch detection and processing circuitry, a pointing device, such as a mouse, and so on. In general, inputs to system 650 may come from any of a variety of sources, machine generated and/or human generated.

Chipset 660 may also interface with one or more communication interfaces 690 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 655 analyzing data stored in storage device 670 or RAM 675. Further, the machine may receive inputs from a user through user interface components 685 and execute appropriate functions, such as browsing functions by interpreting these inputs using processor 655.

It may be appreciated that example systems 600 and 650 may have more than one processor 610 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A computer-implemented method for generating an interactive display, the method comprising:
receiving, by a computing system, a plurality of real-time event data comprising a plurality of real-time event actions of a player;
updating, by the computing system, one or more event actions associated with a unique identifier of the player with the plurality of real-time event actions;
generating, by the computing system, a unique index based on a plurality of weights applied to the one or more event actions associated with the unique identifier, wherein the unique index is generated in real-time as the plurality of real-time event data is received;
generating, by the computing system, an interactive display including at least a graphical representation of the one or more event actions associated with the unique identifier, a graphical representation of the plurality of weights applied to the one or more event actions, and the unique index, wherein the interactive display is generated in real-time as the plurality of real-time event data is received; and
transmitting, to a user interface by the computing system, the interactive display.

2. The computer-implemented method of claim 1, wherein the interactive display is formatted according to a set of ordering rules.

3. The computer-implemented method of claim 2, wherein the ordering rules comprise a first ordering rule, the first ordering rule comprising displaying a first unique index relative to a second unique index in the interactive display based on the first unique index including a higher numerical value relative to the second unique index.

4. The computer-implemented method of claim 1, wherein the plurality of real-time event actions of the player include at least one of a scored goal, a completed pass, an interception, a goal conceded, or no action.

5. The computer-implemented method of claim 1, wherein the unique index is provided to an artificial intelligence predictive model as an input.

6. The computer-implemented method of claim 1, wherein the plurality of weights are applied to the one or more event actions according to a set of rules.

7. The computer-implemented method of claim 1, wherein the interactive display is configured to be filtered according to one or more of unique index or unique identifier.

8. A system for generating an interactive display, the system comprising:
a memory storing instructions and a processor operatively connected to the memory and configured to execute the instructions to perform operations including:
receiving, by a computing system, a plurality of real-time event data comprising a plurality of real-time event actions of a player;
updating, by the computing system, one or more event actions associated with a unique identifier of the player with the plurality of real-time event actions;
generating, by the computing system, a unique index based on a plurality of weights applied to the one or more event actions associated with the unique identifier, wherein the unique index is generated in real-time as the plurality of real-time event data is received;
generating, by the computing system, an interactive display including at least a graphical representation of the one or more event actions associated with the unique identifier, a graphical representation of the plurality of weights applied to the one or more event actions, and the unique index, wherein the interactive display is generated in real-time as the plurality of real-time event data is received; and
transmitting, to a user interface by the computing system, the interactive display.

9. The system of claim 8, wherein the interactive display is formatted according to a set of ordering rules.

10. The system of claim 9, wherein the ordering rules comprise a first ordering rule, the first ordering rule comprising displaying a first unique index relative to a second unique index in the interactive display based on the first unique index including a higher numerical value relative to the second unique index.

11. The system of claim 8, wherein the plurality of real-time event actions of the player include at least one of a scored goal, a completed pass, an interception, a goal conceded, or no action.

12. The system of claim 8, wherein the unique index is provided to an artificial intelligence predictive model as an input.

13. The system of claim 8, wherein the plurality of weights are applied to the one or more event actions according to a set of rules.

14. The system of claim 8, wherein the interactive display is configured to be filtered according to one or more of unique index or unique identifier.

15. A non-transitory computer-readable medium storing instructions that, when executed by one or more processors, perform operations including:
receiving, by a computing system, a plurality of real-time event data comprising a plurality of real-time event actions of a player;
updating, by the computing system, one or more event actions associated with a unique identifier of the player with the plurality of real-time event actions;
generating, by the computing system, a unique index based on a plurality of weights applied to the one or more event actions associated with the unique identifier, wherein the unique index is generated in real-time as the plurality of real-time event data is received;
generating, by the computing system, an interactive display including at least a graphical representation of the one or more event actions associated with the unique identifier, a graphical representation of the plurality of weights applied to the one or more event actions, and the unique index, wherein the interactive display is generated in real-time as the plurality of real-time event data is received; and
transmitting, to a user interface by the computing system, the interactive display.

16. The non-transitory computer-readable medium of claim 15, wherein the interactive display is formatted according to a set of ordering rules.

17. The non-transitory computer-readable medium of claim 16, wherein the ordering rules comprise a first ordering rule, the first ordering rule comprising displaying a first unique index relative to a second unique index in the interactive display based on the first unique index including a higher numerical value relative to the second unique index.

18. The non-transitory computer-readable medium of claim 15, wherein the plurality of real-time event actions of the player include at least one of a scored goal, a completed pass, an interception, a goal conceded, or no action.

19. The non-transitory computer-readable medium of claim 15, wherein the plurality of weights are applied to the one or more event actions according to a set of rules.

20. The non-transitory computer-readable medium of claim 15, wherein the interactive display is configured to be filtered according to one or more of unique index or unique identifier.
